(19) United States
(12) Patent Application Publication
(10) Pub. No.: US 2005/0203714 A9
(43) Pub. Date: Sep. 15, 2005

(54) System and process for charting the time and position of contestants in a race

(76) Inventor: Fernando Vincenzini, Glen Cove, NY (US)

Correspondence Address: WILLIAM COLLARD;COLLARD & ROE, P.C., 1077 NORTHERN BOULEVARD, ROSLYN, NY, 11576, US

(21) Appl. No.: 10/860,867

(22) Filed: Jun. 3, 2004

Related U.S. Application Data
(63) Continuation-in-part of application No. PCT/US02/38459, filed on Dec. 3, 2002.
(60) Provisional application No. 60/336,620, filed on Dec. 3, 2001.
(60) Provisional application No. 60/577,430, filed on Jun. 3, 2004.

(51) Int. Cl. A63F 9/24; A63F 13/00

(52) U.S. Cl. 702/150

(57) ABSTRACT

A system and a process for determining the timing and position of contestants on a track. This system comprises at least one set of two trapezoidal shaped loops that have a longitudinal axis that project from an inside rail to an outside rail on the track. There is also at least one competitor communication device that can be coupled to each contestant. A remote base station, is in communication with the positioning device, wherein the positioning device determines a contestant time as the contestant passes the wire loop and also determines the position of the contestant in relation to an inside guide such as a rail. A relay positioned in the center of the track can also be used to increase the signal flowing between the base station and the positioning device. The process for determining the position and timing of each contestant in a race includes the steps of attaching at least one competitor communication device on at least one individual contestant. Next, the race starts, whereby during the race, the position and time for each contestant is recorded. Next a signal is transmitted from the competitor communication device to a remote base station. Finally, these signals are synchronized so that there is no interference.

### CROSS REFERENCE TO RELATED APPLICATIONS

This application claims priority under 35 U.S.C. 120 from PCT application Ser. No. US/02/38459 filed on Dec. 3, 2002 wherein this application also claims priority under 35 U.S.C. 119e from Provisional application Ser. No 60/336,620 filed on Dec. 3, 2001, this application also claims priority under 35 U.S.C. 119e from a provisional application filed on Jun. 3, 2004 wherein the disclosures of both provisional applications and the PCT application are hereby incorporated herein by reference.

### BACKGROUND OF THE INVENTION

1. Field of the Invention

The invention relates to a system and a process for determining the time and position of a contestant in a race. More particularly, the invention relates to a system and a process for determining the times for each contestant at particular positions or splits in a race and for determining the position of each contestant in relation to an inside guide, or rail of the track at each of these particular splits.

Timing and position systems are known in the art. For example the following U.S. Patents generally disclose timing and/or positioning systems for contestants in a race: U.S. Pat. Nos. 6,072,751; 5,844,861; 5,737,280; 5,138,550; 4,774,679; 4,571,698; 4,274,076; 4,142,680; 3,946,312; 3,795,907; and 3,781,529 wherein the disclosures of which are herein incorporated by reference.

### SUMMARY OF THE INVENTION

The invention relates to a system and a process for determining the timing and position of contestants on a track. This system comprises at least one wire loop disposed above, below or adjacent to a track, and disposed at a particular position or split on the track. There is also at least one competitor communication device (CCD) that can be coupled to each contestant. There is also at least one remote base station, wherein the competitor communication device determines a contestant time as the contestant passes the wire loop. The wire loop in one embodiment can be formed as two trapezoidal shaped loops that have a longitudinal axis that project from an inside rail to an outside rail on the track. On the inside rail the trapezoidal shaped loops are narrower, while on the outside rail the trapezoidal shaped loops are wider.

These trapezoidal loops create a magnetic field that has at least two nulls, wherein via reading these nulls, the position of each contestant in relation to the rail can be determined. This feature is particularly useful in determining the performance of a competitor wherein during a race, this performance will be processed and presented in real time and published for future race handicapping.

The CCD comprises a positioning sensor in the form of a coil for reading the magnetic field from these loops. An amplifier which can be a logarithmic amplifier and a tuning capacitor may also be coupled to this coil. This sensor is coupled to a microprocessor and to a power input. The power input can be in the form of a battery that may also include a DC-DC boost converter to give the components a 5V power supply. In addition, coupled to the microprocessor and the power input is a transceiver wherein there is an antenna coupled to the transceiver. In addition, a video and audio input is also coupled to the power input and to the microprocessor.

The microprocessor can include a set of instructions that creates a unique identity for the microprocessor. This unique identity allows the remote base station to track each individual contestant individually and to match the time and position of each individual contestant on the track for handicapping of a race or for race analyzation processes.

The microprocessor can also include a synchronization protocol which sets periodic transmissions of signals from at least one transceiver to the at least one remote processing or base station. This synchronization protocol can be a time division multiple access (TDMA) protocol where collision is avoided by assigning each transceiver its own time slot.

This microprocessor also controls the audio and video transmission from each contestant so that the audio and video transmission is sent from only one contestant at a time.

There is also a process for determining the position and timing of each contestant in a race. This process includes the steps of attaching at least one CCD on at least one individual contestant. Next, the race starts, whereby during the race, the position and time for each contestant is recorded. Next a signal is transmitted from the CCD to a remote base station. Finally, these signals are synchronized so that there is no interference.

In another embodiment of the invention, the CCD is a three dimensional magnetic field sensor which detects an absolute value of an ambient AC magnetic field. This absolute value depends on the sensor's position in space but not on the sensor's rotation.

The sensor consists of a plurality of XYZ coils which pick up the X Y and Z component of the field. The coil signals are then amplified by a set of amplifiers each connected to the XYZ coils. The amplitude of the signals fed from the amplifiers is detected by a plurality of amplitude detectors in communication with each of the amplifiers. There are then a set of analog to digital converters with at least one analog to digital converter in communication with each of the amplitude detectors. These analog to digital converters then feed into a microprocessor, which in turn calculates the absolute value of the magnetic field.

With this second embodiment, there is also a loop of wires that generate a signal to be read by a sensor. The loop of wires essentially form a trapezoidal shape along a vertical plane above a racetrack. The trapezoidal shape of the wires is used to determine the position of each of the sensors as the sensor crosses the wire.

In another embodiment of the invention the loops can be placed along an inside rail of a racetrack wherein these loops can be in the form of elongated loops extending along a length of the track.

In another embodiment of the invention, the loops can be extended above a racetrack wherein two loops can be disposed above competitors and extend substantially parallel to each other.

### BRIEF DESCRIPTION OF THE DRAWINGS

Other objects and features of the present invention will become apparent from the following detailed description considered in connection with the accompanying drawings which disclose at least one embodiment of the present invention. It should be understood, however, that the drawings are designed for the purpose of illustration only and not as a definition of the limits of the invention.

In the drawings wherein similar reference characters denote similar elements throughout the several views:

FIG. 1 is a perspective view of one embodiment the system installed on a track;

FIG. 2 is a top view of loops associated with the embodiment of FIG. 1;

FIG. 3 is a schematic block diagram of a first embodiment of the competitor communication device (CCD);

FIG. 4 is a schematic block diagram of a infrared receiving device;

FIG. 5 is a schematic block diagram of a remote infrared terminal associated with the second embodiment of the device shown in FIG. 4;

FIG. 6 is a graph of the magnetic reading of the device as it travels under horizontally positioned loops;

FIG. 7 is a graph of the magnetic reading of the device as it travels under vertically positioned loops;

FIG. 8 is a schematic block diagram of the remote base station;

FIG. 9 is a schematic block diagram of a second embodiment of a sensor;

FIG. 10 is a top view of a second embodiment installed on a track;

FIG. 11a is a representation of a second embodiment of the wire loop;

FIG. 11b is a representation of a third embodiment of the wire loop;

FIG. 12 is a representation of a calculation from the wire loop;

FIG. 13 is a graph of a signal reading to determine when the sensor of FIG. 9 crosses under the loop shown in FIG. 11;

FIG. 14 is a positioning graph of a signal reading to determine the position of the sensor on the track as the sensor crosses under the loop shown in FIG. 11;

FIG. 15 is a second positioning graph of a signal reading to determine the position of the sensor of FIG. 9 on the track as the sensor crosses under the loop shown in FIG. 11;

FIG. 16 shows another embodiment of a tracking station which contains a plurality of loops;

FIG. 17 shows the loops of FIG. 16 placed around a track;

FIG. 18 shows a graphical representation of a signal generated by the loops of FIG. 16;

FIG. 19 shows a graphical representation of the signal of FIG. 18 amplified by a logarithmic amplifier;

FIG. 20 is a perspective view of another embodiment of a series of loops placed adjacent to an inside rail of a track;

FIG. 21 is a graph of a reading taken from a sensor interacting with the loops shown in FIG. 20;

FIG. 22 is a plan view of another embodiment of the invention which shows the placement of loops over a track;

FIG. 23 shows a perspective view of the loops shown in FIG. 22;

FIG. 24 shows a front end view of the loops shown in FIG. 23; and

FIG. 25 shows a sensor reading from the loops shown in FIG. 24.

### DETAILED DESCRIPTION OF THE PREFERRED EMBODIMENT

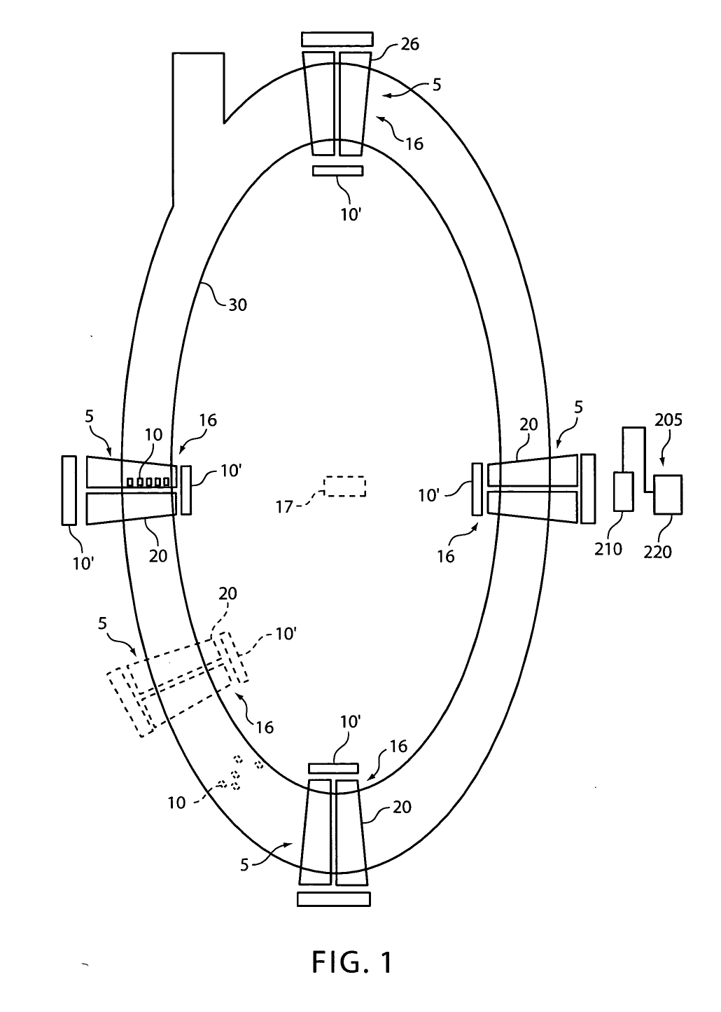

Referring to the drawings, FIG. 1 is a plan view of the system 5 which includes the (CCD) 10 which is coupled to a contestant such as a horse. There is also shown a plurality of tracking stations 16 disposed around the track. These tracking stations 16 contain a plurality of loops 20 and are in communication with a relay 17 disposed in a center region of a track. Relay 17 is for amplifying the signal generated from stations 16.

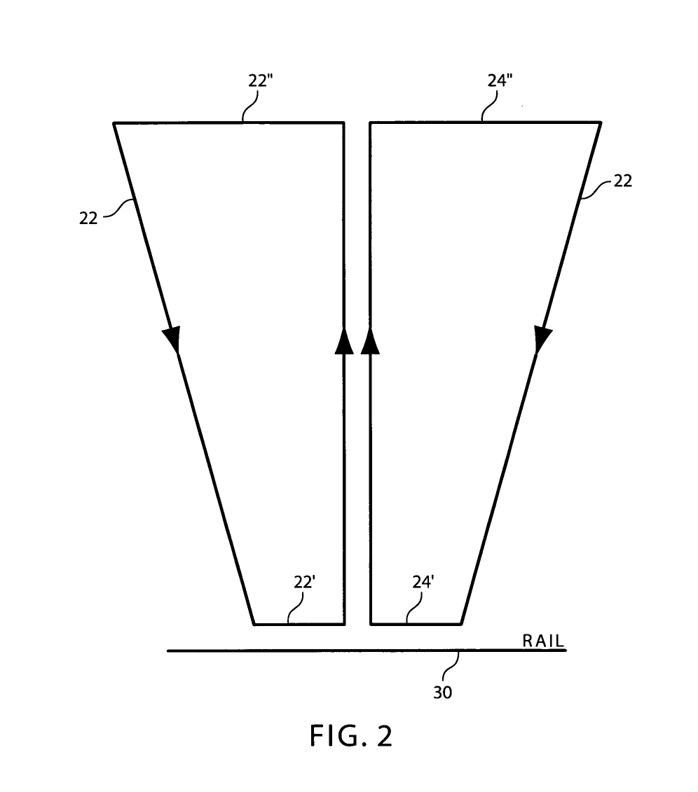

Loops 20 comprise a first trapezoidal loop 22 and a second trapezoidal loop 24. Loops 20 are held above a race track such as a horse track wherein as shown in FIG. 2, loop 22 contains an inside section 22′ that is adjacent to a rail and an outside section 22″. Inside section 22′ is narrower than outside section 22″. In addition, loop 24 includes inside section 24′ and outside section 24″. As with loop 22, inside section 24′ which is closer to the rail, is narrower than outside section 24″.

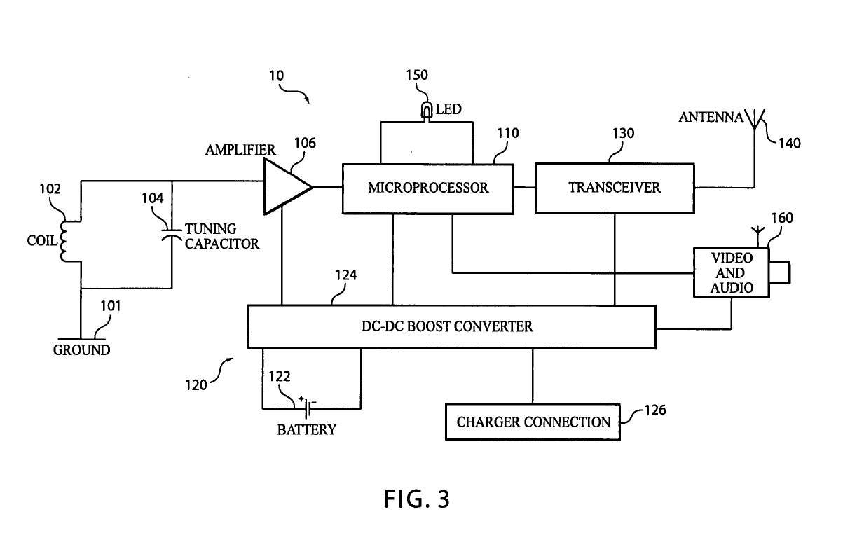

FIG. 3 shows a schematic block diagram of the CCD 10. This device comprises a position sensor 100 which includes a coil 102, a tuning capacitor 104 and an amplifier 106. Position sensor 100 interacts with magnetic fields created by loops 22 and 24 on the track to determine the position and time of the individual contestant at a particular period of time during the race. Coil 102 is positioned along the X-axis, so that it can read the nulls that occur in the X-component of the magnetic field generated by the loops.

Microprocessor 110 is coupled to amplifier 106, whereby microprocessor 110 contains instructions to control the transfer of signals, the individual timing of the contestant, and to carry a unique identifier to identify each individual contestant.

Coupled to microprocessor 110 is transceiver 130, which can send and receive signals from microprocessor 110 through antenna 140 to and from a base station. There is also a power input 120 which is coupled to amplifier 106, microprocessor 110, transceiver 130, and video and audio input 160. Power input 120 comprises a battery 122, a DC-DC boost converter 124 and a charger connection 126. Battery 122 sends power through DC-DC boost converter 124 such that converter 124 delivers 5V of power supply into the components in the system. Charger connection 126 works in unison with LED 150 and battery 122 so that when battery 122 runs down, LED 150 changes from green to red to indicate that the battery is running out of power. Conversely, once the battery has been fully recharged, LED 150 changes color back from red to green to indicate a full charge.

Video and Audio input 160 is essentially a motion video camera with a microphone that can be placed on a contestant such as a horse. With a horse, the camera would most likely be placed on the back of a saddle to capture moving images behind the horse. Microprocessor 110 would then control the sending of this information to a remote base station depending on instructions sent from that remote base station.

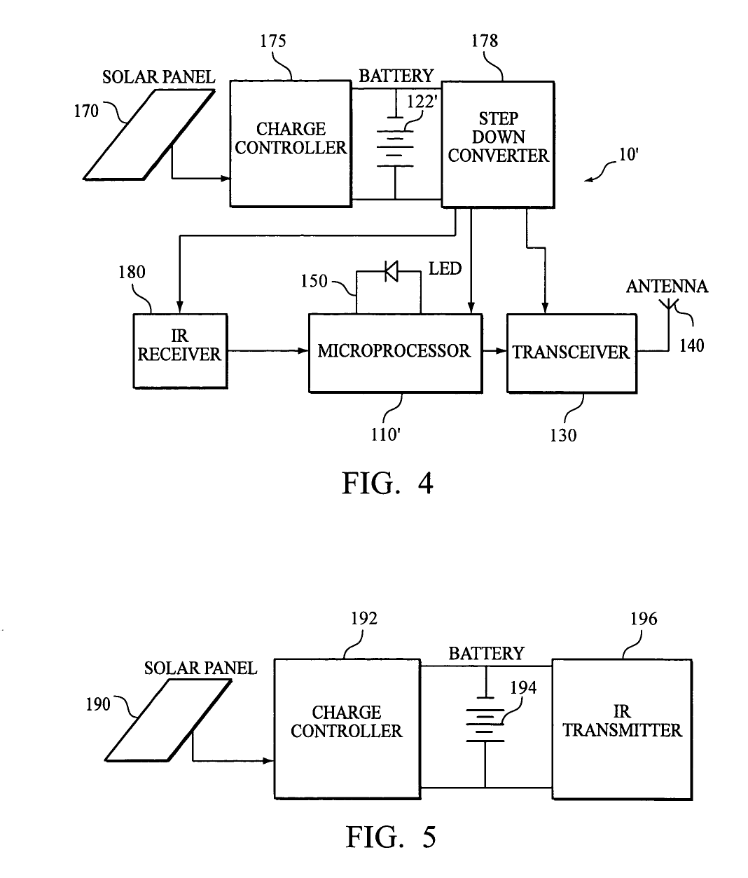

FIG. 4 shows an embodiment of the infrared tracking system 10′. This tracking system 10″, includes solar power in the form of a solar powered panel 170 fixed into the system. Panel 170 is coupled to charge controller 175. Charge controller 175 is coupled to battery 122″. Both charge controller 175 and battery 122′ are coupled to step down converter 178. Step down converter 178 converts the energy input from both charge controller 175 and battery 122′ into usable energy for the remaining components. These components include microprocessor 110′ which functions similar to microprocessor 110, and transceiver 130 which is essentially identical to transceiver 130 in FIG. 3. In addition, antenna 140 is coupled to transceiver 130 as well.

With this embodiment, there is an infrared or IR receiver 180 coupled to microprocessor 110′. IR receiver 180 is used as a position sensor to determine the time and position of the individual contestant as that contestant is racing in a race. Essentially, IR receiver 180 receives an infrared beam from IR transmission device 185. IR receiver 180 and IR transmission device 185 are positioned at a start pole for the race so that at the start of the race, these devices can track the start of the race. Thus when the race starts, this beam is broken and then a signal is sent to a base station to start the race clock.

IR transmission device 185 includes solar panel 190, a charge controller 192 for controlling the charge from solar panel 190, a battery 194 and an IR transmitter 196 for transmitting position signals to and from each contestant.

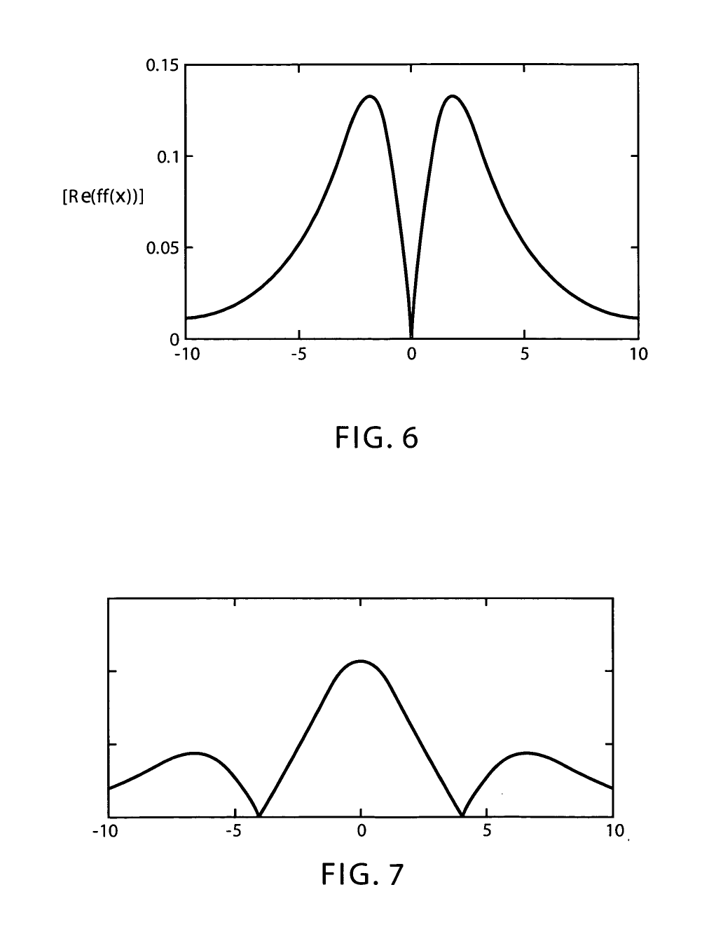

FIG. 6 shows the X-component of the field read by the CCD 10 as it passes a single section loop. A two-section loop as in FIG. 2 will produce the readout of FIG. 7. The narrower the loop, the closer will be the nulls on FIG. 7. With a trapezoidal loop, the distance between nulls that the CCD reads will be proportional to its distance from the rail.

Because there is both an IR based system and a magnetic based system at each terminal, this provides a redundant system for tracking the race contestants. The IR based system does not contain information relating to the identity of each contestant. However, the IR based system does relay the time that the first competitor crosses each mark. Thus, at a very minimum, this IR based system can be used to verify the start and ending times of a race.

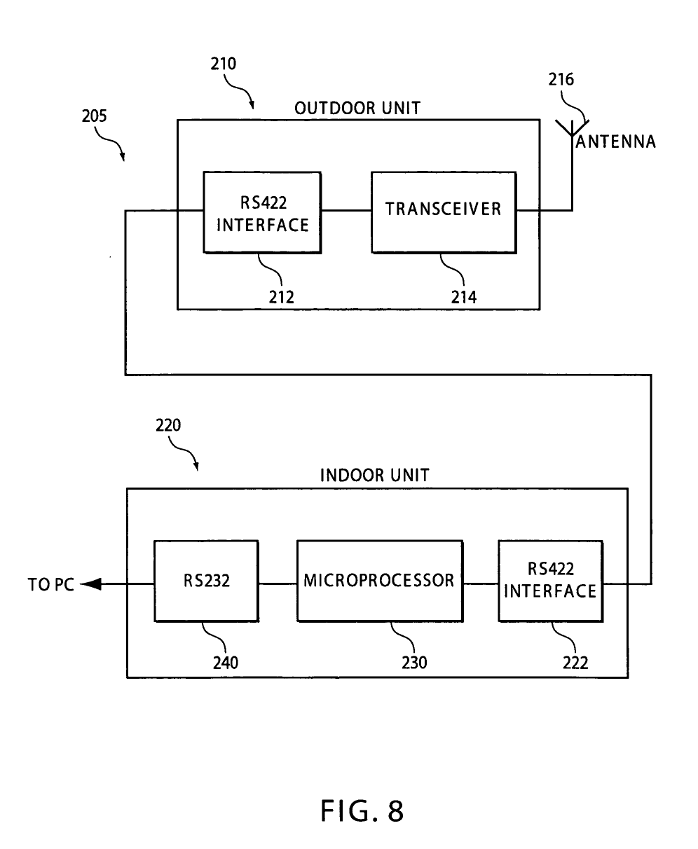

FIG. 8 is a schematic block diagram of a base station 205 which is also shown in FIG. 1. Base station 205 includes an outdoor unit 210 and an indoor unit 220. Outdoor unit 210 includes an RS422 interface which is coupled to a transceiver 214. Transceiver 214 is also coupled to an antenna 216 which is designed to receive signals from antenna 140 on device 10. Essentially information in the form of signals flows into antenna 216 from one or more devices 10 during a race. This information is sent through transceiver 214 and then through RS422 interface 212 and then onto indoor unit 220. Indoor unit 220 also includes a RS422 interface 222 and a microprocessor 230. Essentially, these RS 422 interfaces allow communication between the outdoor and indoor devices via appropriate cabling. Microprocessor 230 reads and identifies these signals and also sends signals back through outdoor unit 210 to control the protocol and sending of transmissions from devices 10. Information from microprocessor 230 is then sent on to RS 232 interface 240 which then transfers this information on to a personal computer for transmission to an internet site or to post results internally for handicapping.

The system operates as follows: each contestant receives a competitor communication device 10 which can be attached to each contestant by any known means such as a belt, a strap, etc. This device is turned on and it may run one or more test signals to base station 205 so that each device 10 is pretested to communicate with base station 205. Each contestant lines up at a starting line which contains loops 20 and the infrared system which projects an infrared beam. A race indicator goes off whereby the contestants are notified of the start of the race. This start may occur via a gun, bell, or a horn sounding. As the first contestant passes and breaks the infrared beam, a signal is sent to base station 205 indicating the start of the race. This breaking of the infrared beam starts the race clock. Next, as each contestant crosses a null period in the magnetic field created by loops 20, this causes a second signal to be sent to base station 205 for each contestant. This second signal starts the individual race clocks for each contestant. Thus, there are many clocks running at one time. First, there is a universal race clock which determines the universal race time. There are also individual clocks that determine the split times for each competitor's split. These separate times are useful because it allows the analyzation of the true starting times for each contestant. Thus, if a contestant is quick off of the start there will be little or no time lag between the universal race time and that individual competitor's race time. However, if the contestant is slow off the start, then there will be a large or even larger time lag for that competitor.

As each contestant or competitor crosses each of the splits, the times for each contestant is sent to base station 205. In addition, when the first contestant crosses that split station, the infrared system sends a signal for the race split as well. All of the competitors race around the track until they reach the finish line whereby as they reach the finish line, their times are clocked into base station 205. The overall winning race time stops when the first competitor crosses the infrared beam of the finish line.

During this race, the position of each individual contestant is also recorded. The position of each contestant at each split is also sent to base station 205 and recorded. In addition, during this entire race, base station 205 is controlling processor 110 in competitor communication device 10 to determine whether to send audio and video signals. In addition, base station 205 is controlling the transmission of this information via a synchronized relay system explained above so that there is no interference of signals from any of the CCDs.

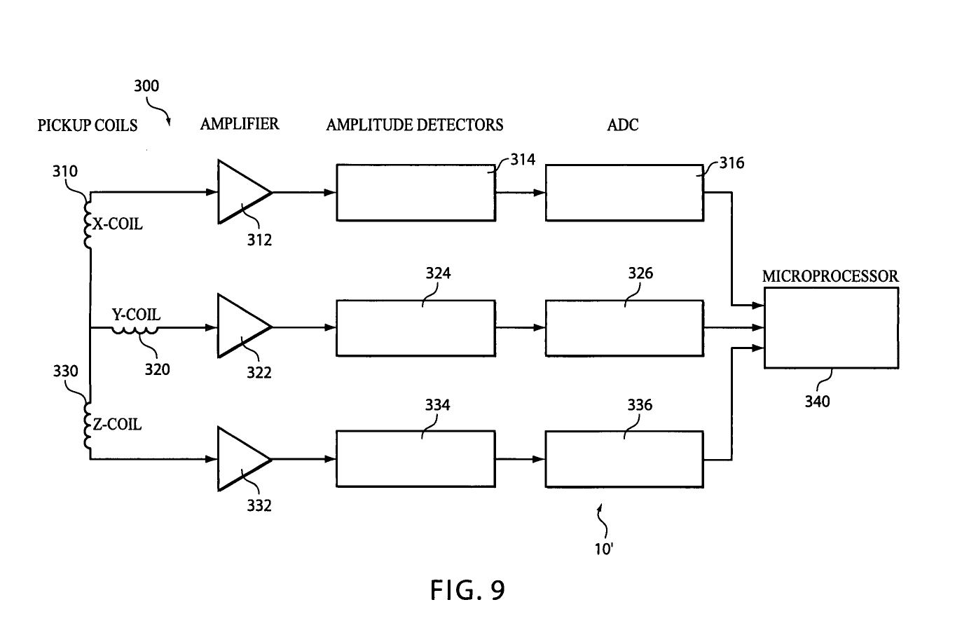

FIG. 9 is a schematic block diagram of a second embodiment of a sensor or CCD 300 which contains an x coil 310, a y coil 320 and a z coil 330. An amplifier 312, is in communication with x coil 310 while an amplifier 322 is in communication with y coil 320 while a third amplifier 332 is in communication with z coil 330. There is also a set of amplitude detectors 314, 324 and 334 with amplitude detector 314 in communication with amplifier 312, amplitude detector 324 in communication with amplifier 322, and amplitude detector 334 in communication with amplifier 332. A set of analog to digital converters (ADC) 316, 326, and 336 are also coupled to the amplitude detectors 314, 324, and 334 respectively. With this connection, ADC 316 is in communication with amplitude detector 314, ADC 326 is in communication with amplitude detector 316, and ADC 336 is in communication with amplitude detector 326. Finally, a microprocessor 340 is in communication with ADCs 316, 326 and 336 at a downstream end.

The sensor operates as follows, x, y, and z components of a signal are picked up by x, y, and z coils 310, 320 and 330 respectively. The components of this signal are fed from these coils into their respective amplifiers 312, 322, and 332. The coil signals are amplified by the amplifiers and then the amplitude of each of these signals is obtained by the amplitude detectors 314, 324, and 334 respectively. These amplitudes are then digitized by the ADCs 316, 326, and 336 respectively wherein this information is fed into microprocessor 340.

The microprocessor then calculates the absolute value of the magnetic field using a program that follows the following formula:
B=√\overline{x²+y²+z²}
where B is the magnetic field;
x, horizontal position in the direction of the rail;
y is the horizontal position from or perpendicular to the rail;
z is the vertical position.

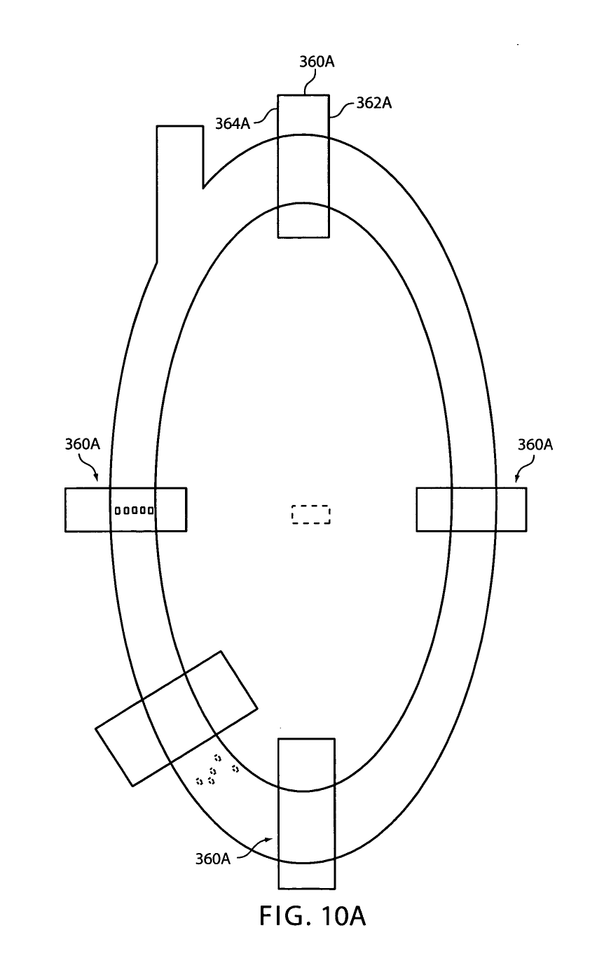

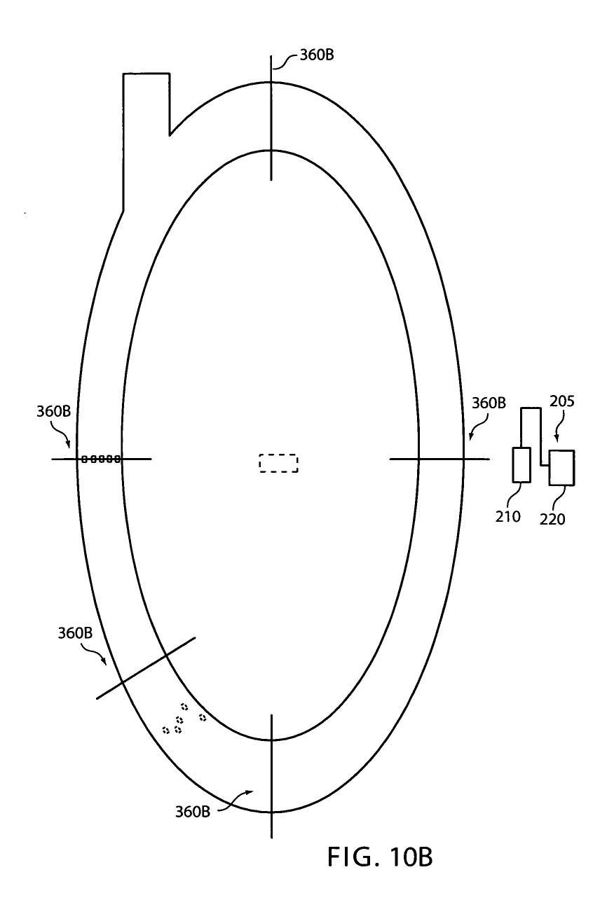

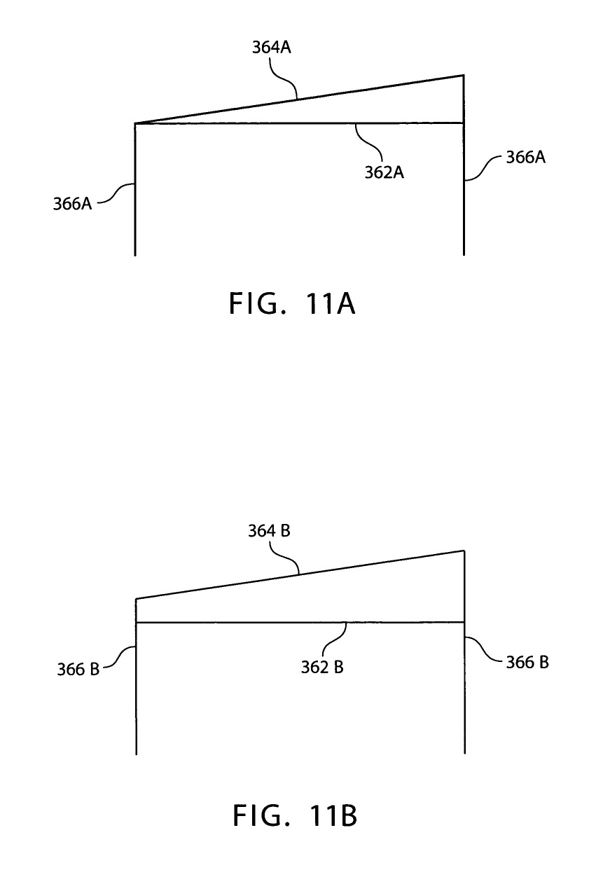

FIG. 10A is a top view of a second embodiment of a track 350A which shows loops 360A disposed at different locations about the track. Loops 360A are spaced from the track at uneven distances from the rail to the outside of the track as shown in FIG. 11A. Loop 360A essentially contains a first wire 362A and a second wire 364A wherein first wire 362A and second wire 364A are elevated above a track via elevation poles 366A.

FIG. 10B is a top view of a third embodiment of a track 350B which shows vertical loops 360B disposed at different locations about the track. Loops 360B are trapezoidal shaped loops as shown in FIG. 11B. Loop 360B contains a first wire 362B and a second wire 364B which are elevated above a track via elevation poles 366B.

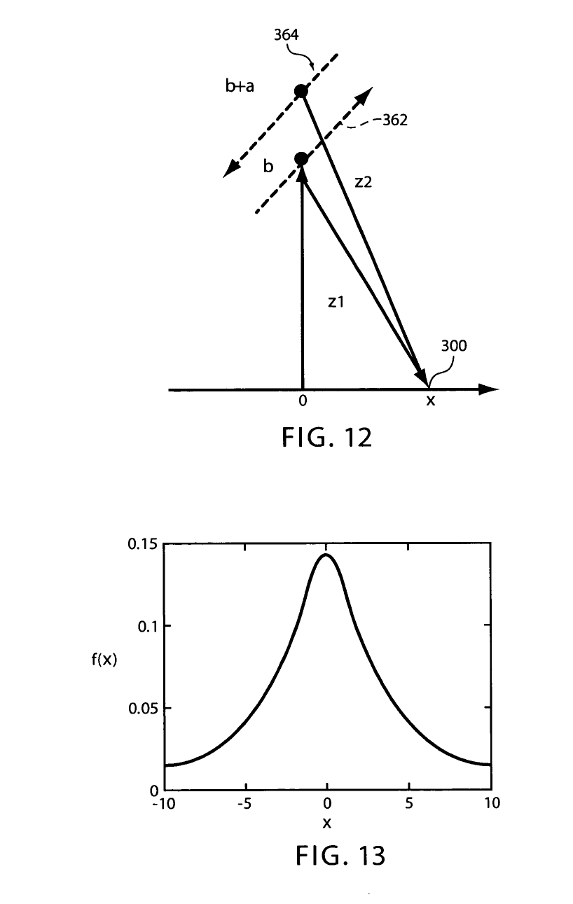

FIG. 12 shows a diagram used to derive a formula for the magnetic field under a vertical loop, with first wire 362 positioned at a first height b and second wire 264 positioned at a second height b+a. Both of these wires are spaced apart respect to a position of a sensor 300 by a distance z1 for wire 362 and z2 for wire 364 wherein sensor 300 is positioned from elevation poles 366 by a distance x.

The vectors z1 and z2 from the two wires to point x are z1=x−ib and z2=x−i(b+a).

If the loop current is I, the magnetic field produced by each of the wires will be:

$$\begin{matrix}B1 = \frac{2 I {μ}_{0}}{4 π} ( - i \frac{z1}{{\vert z1 \vert}^{2}} ) \\ and \\ B2 = \frac{2 I {μ}_{0}}{4 π} ( i \frac{z2}{{\vert z2 \vert}^{2}} )\end{matrix}$$

Thus the resulting field B will then be the sum of fields B1 and B2:

$$B = \frac{2 I {μ}_{0}}{4 π} ( - i \frac{z1}{{\vert z1 \vert}^{2}} + i \frac{z2}{{\vert z2 \vert}^{2}} )$$

The sensor will then be used to detect |B|. After substituting z1 and z2 and doing the math, the formula for the absolute value of B as a function of the sensor position x is:

$$\begin{matrix}B ( x ) = \frac{2 I {μ}_{0}}{4 π} \frac{a}{\sqrt{( {x}^{2} + {b}^{2} ) ( {x}^{2} + {( b + a )}^{2} )}} \\ or \\ B = \frac{2 I {μ}_{0}}{4 π} f ( a , b , x ) \\ where : \\ f ( a , b , x ) = \frac{a}{\sqrt{( {x}^{2} + {b}^{2} ) ( {x}^{2} + {( b + a )}^{2} )}}\end{matrix}$$

is a function of the sensor position x, the loop height above sensor b, and a loop width a.

FIG. 13 is a graph of a signal reading to determine when the sensor of FIG. 9 crosses under the loop shown in FIGS. 11A or 11B. This graph shows a reading for the function f(x) described above wherein b=2.6 meters and a=1.5 meters. Microprocessor 340 can then easily read the peak of this function to determine the timing and position of sensor 300 as sensor 300 passes loop 360.

To detect a position of sensor 300 with respect to a rail, the vertical loop is made with different heights at both ends of the track so that it produces a difference in shape of the magnetic field on both sides. In turn, the shape of this signal can be used to detect an inside or outside position via CCD 300 based upon an amplitude of a received magnetic signal.

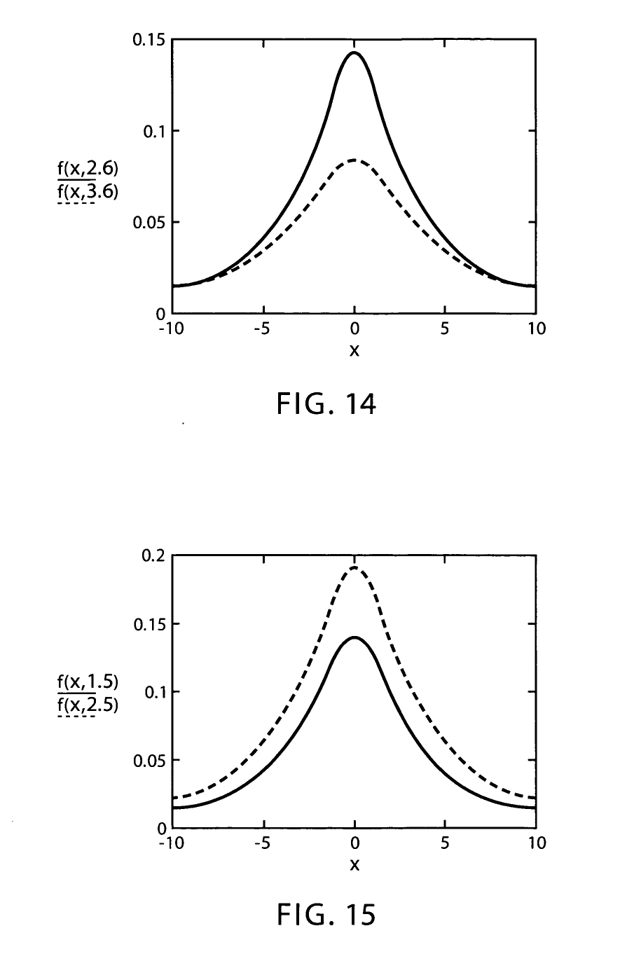

FIG. 14 is a positioning graph of a signal reading to determine the position of the sensor on the track as the sensor crosses under the loop shown in FIG. 11A. Thus, for example if the loop wires are spaced parallel apart from each other by 1.5 meters but at a height of 2.6 meters on an inside rail and 3.6 meters on the outside then the resulting field would be shown in FIG. 14.

FIG. 15 is a second positioning graph of a signal reading to determine the position of the sensor of FIG. 9 on the track as the sensor crosses under the loop shown in FIG. 11B. This loop has the lower wire 362 positioned at 2.6 meters with the top wire 364 positioned above lower wire 362 by 1.5 meters on the inside and 2.5 meters on the outside. Thus, FIG. 15 shows the final graphical reading of this sensor.

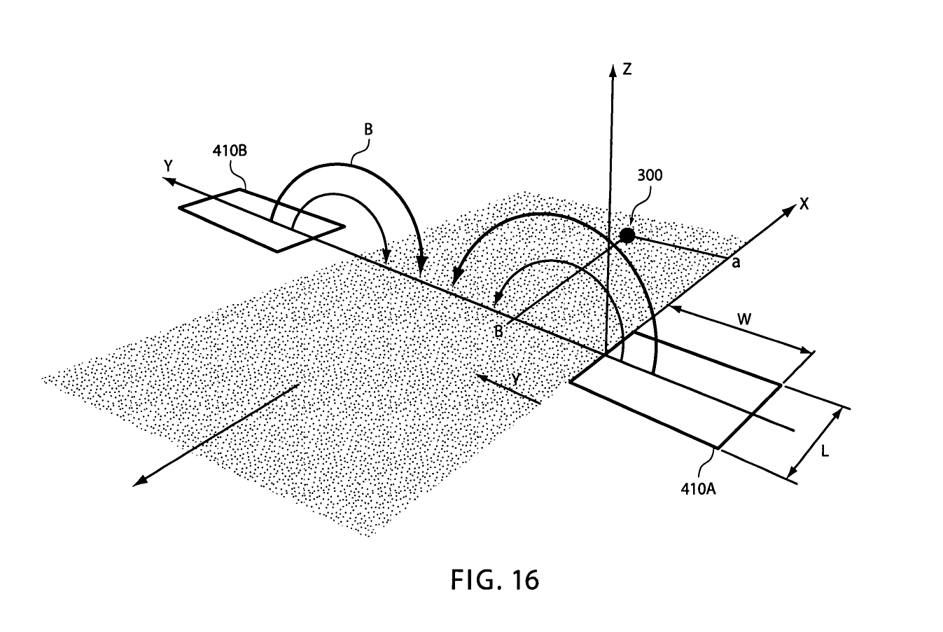

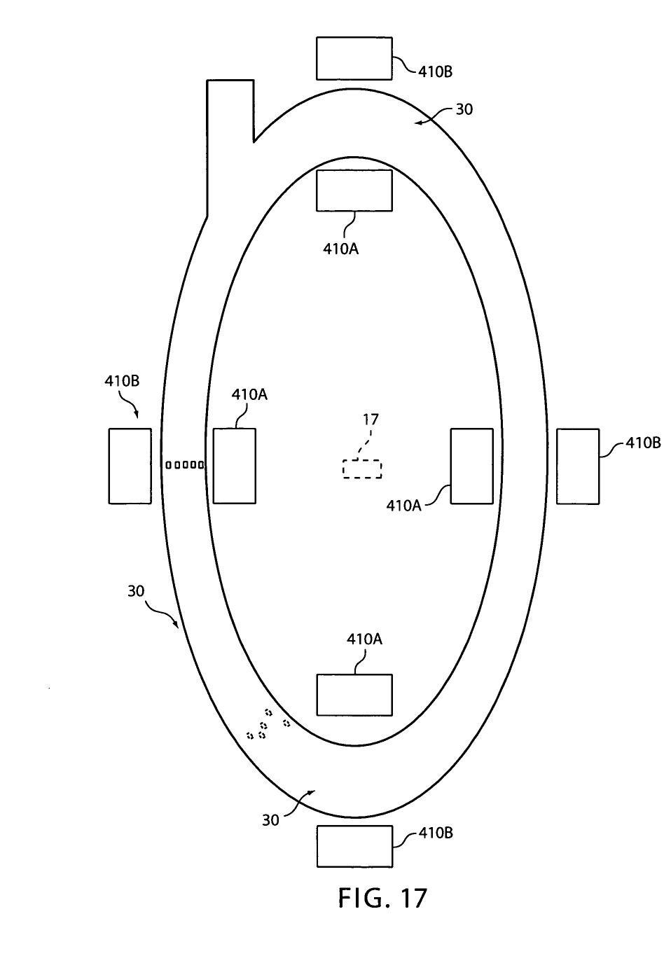

FIG. 16 is another embodiment of the invention. This embodiment differs by the method used to create the ambient magnetic field and is aimed at installations where it is undesirable to place any wires across the track. The field is created by two separate loops 410a and 410b on both sides of the track they are driven by separate power sources with 125 kHz sinusoidal current. Furthermore, their current phases are synchronized via a high frequency RF signal. This synchronization ensures that the magnetic fields from the loops are always in phase and add, rather than subtract. FIG. 17 shows the positioning of this embodiment on a track. For example loop 410A is positioned along an inside rail of the track while loop 410B is positioned along an outside rail of the track.

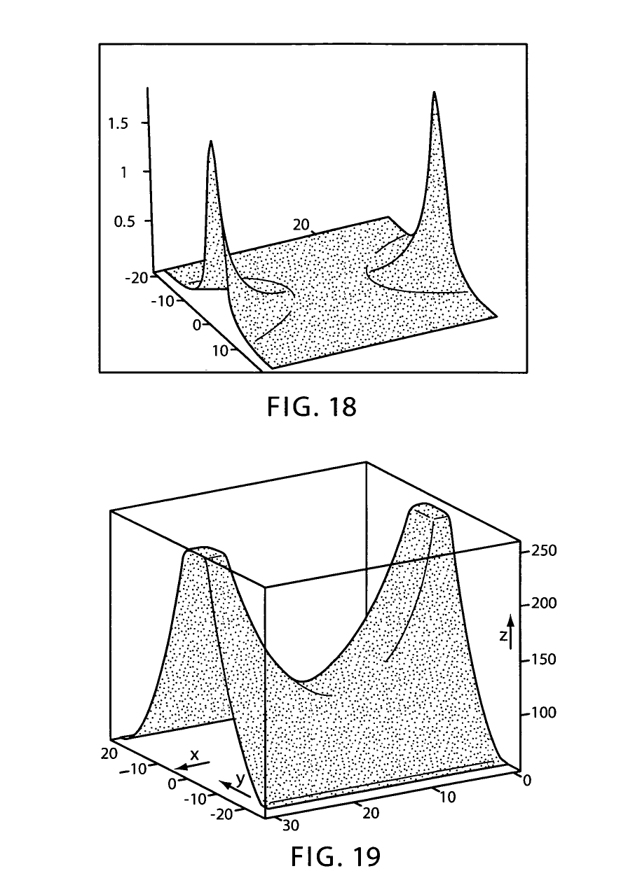

FIG. 18 shows the magnetic field numerically calculated for a 30 meter wide track with two 4×4 meter loops on both sides such as those shown in FIGS. 16 and 17. It is obvious that the field vanishes very quickly and becomes negligible around the middle of the track.

Nevertheless, this embodiment is made feasible by utilizing a logarithmic amplifier such as Analog Devices AD 8307 in the CCD. FIG. 19 shows a computer simulation of the CCD pickup value when such and amplifier is used. The magnetic field peak becomes strong enough for reliable detection even at its weakest point in the middle of the track.

The magnetic field of a single wire of a square frame is calculated as:

$$\vec{B} = \frac{{μ}_{0}}{4 \cdot π} \cdot I \cdot {e}_{z} \cdot {\int }_{- \frac{L}{2}}^{\frac{L}{2}} \frac{b}{[ \sqrt{{{( x - a )}^{2} + {b}^{2} ]}^{3}}} ⅆ x$$

wherein:
B: Is the magnetic field;
u0: is a magnetic constant;
a: is the x position of a CCD 10;
b: is the y position of the CCD 10;
L: is a length of a wire loop along the track
I: is the current running through a wire; and

x: is the integration variable.

In addition, for future reference z is the amplitude of the magnetic field while y is the position with respect to the inside rail of the track.

The loop stretches from (−L/2, 0) to (L/2,0) and carries a current I as shown in FIG. 16.
wherein solving the integral is as follows:

$$\begin{matrix}\int \frac{b}{[ \sqrt{{{( x - a )}^{2} + {b}^{2} ]}^{3}}} ⅆ x = \frac{x - a}{b \cdot \sqrt{{( x - a )}^{2} + {b}^{2}}} \\ Wherein \\ f01 ( a , b , x ) := \frac{x - a}{b \cdot \sqrt{{( x - a )}^{2} + {b}^{2}}}\end{matrix}$$

To avoid division by zero for b=0, the function is modified slightly, wherein this will only affect the values of the field for points that are very close to the loop. These points are essentially of no interest because these points are off of the track. These points are calculated as:
g(b):=if (|b|<0.1, 0.1, b)
f0(a,b,x):=f01(a, g(b), x)

For simplicity, we omit the constant multiplier, wherein this constant multiplier is added at the end. The constant multiplier is calculated as:

$$\frac{{μ}_{0}}{4 π} \cdot 1 \cdot {\vec{e}}_{z}$$

Thus, the magnetic field of a straight piece of wire stretched between ((−L/2), 0) and ((L/2),0) and measured in point (a,b) is
B(x,y,L):=f0(x,y,(L/2))−f0(x,y,(−L/2))

Therefore, we can calculate a second piece of wire parallel spaced wire stretching from
((−L/2,−W) to ((L/2),−W)
with the current flowing in the opposite direction.

The magnetic field of these two wires will be:
B2(x,y,L,W):=B(x,y,L)−B(x,y,+W,L)
When using complex numbers the (x,y) coordinates are shown as:
v=x+iy
fcomp(v,L,W):=B2(Re(v), Im(v),L,W)

When another pair of wires are added, these wires intersect the frame and form a rectangular shaped frame. The same formula for inductance can be used wherein the coordinates a,b, of the measured point must be transformed to the coordinate system of the new set of wires. The necessary coordinate transformation is transform:

$$( v , L , W ) := {ⅇ}^{\frac{- z}{2} i} \cdot v + - \frac{L}{2} \cdot i + \frac{W}{2}$$

This way we obtain the magnetic field of the whole frame:
Fframe(v,L,W):=fcomp(v,L,W)+fcomp[(transform(v,L,W)),W,L]

If the frame has a certain number of windings nw then it can be calculated as:
Btotal(x,y,L,W,nw):=nwFframe(x+i×y,L,W)

Finally the magnetic field for both frames is calculated as:
BtwoFrames(x,y,L,W,nw,TW):=Btotal(x,y,L,W,nw)+Btotal(x,y,−TW−W,L,W,nw).

This magnetic field is shown in FIG. 18 wherein the differences are amplified by a logarithmic amplifier which provides the final graph reading in FIG. 19. This reading is then analyzed by analog to digital converters 316, 326, and 336 in CCD 10 to determine the position of the competitor.

The graph shown in FIG. 19 of the magnetic field generated from both wire loops is used to determine the time and position of each competitor because a minimum of amplitude in the x direction as each competitor crosses the magnetic field is used to determine the time that the competitor crosses a timing line or reference point. In addition, the amplitude of this magnetic field with respect to the y direction is used to determine the position of the competitor with respect to the inside rail of the track. Coils 310, 320 and 330 are used along with amplitude detectors 314, 324, and 334 and A/D converters 316, 326, and 336 on CCD 10′ which is also used to calculate this amplitude wherein this amplitude is then converted into a competitor's position in microprocessor 340.

Essentially, the timing and positioning aspects of this invention assist handicappers of races in determining the exact time and position of each contestant in a race. With this information, the handicappers have a competitive advantage over previous handicappers who did not know the exact time of each contestant at each split and the position of each contestant at each split.

In another embodiment of the invention, for each position to be measured, two dipoles can be placed along an inside rail of the track wherein these two dipoles can be electrified to present a field for tracking competitors using a CCD 10. In this case, at each location, there are at least two dipoles 500 and 510 which can be positioned along or adjacent to an inside rail of a racetrack. Each dipole 500 and 510 can be inserted into the ground next to the track, coupled to the inside rail of the track, or placed upon the ground and secured adjacent to the track. These dipoles are powered with a sinusoidal signal with a frequency close to a dipole's resonant frequency. The feed signal for a second dipole 510 is shifted 180 degrees relative to signal D1.

With this arrangement, each dipole will create an electromagnetic field. At a distance far from the dipole, these signals will cancel out each other, due to the 180 degree phase shift so that the far field will be essentially zero. However, adjacent to or relatively close to the dipoles there will be a significantly high near field. The magnetic component of this near field can then be used to power a field for interaction with a CCD 10 which then provides a reading of the position of the CCD 10.

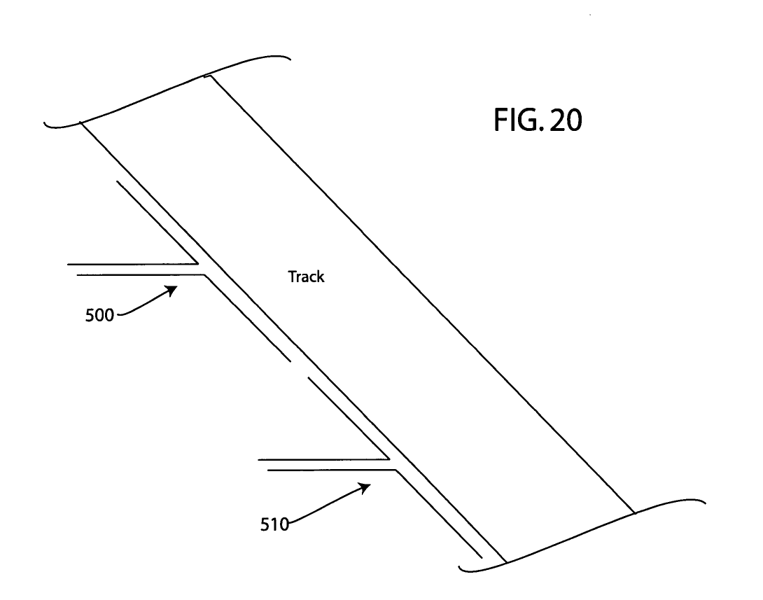

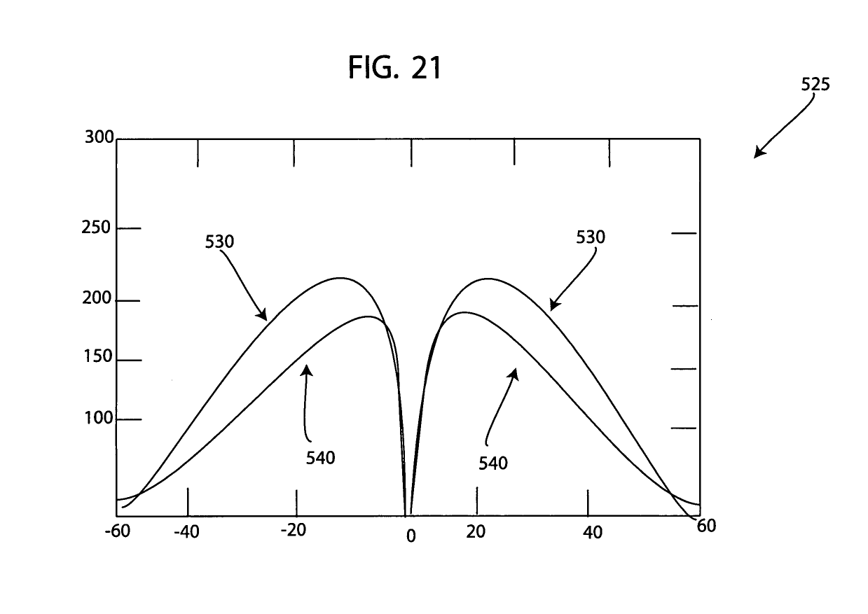

FIG. 20 shows a view of this device wherein dipoles 500 and 510 are shown along an inside rail of an associated track. Dipoles 500 and 510 can extend up to 60 m long each for a total of both dipoles being up to 120 m in length along the track. The ambient magnetic field will create an associated magnetic reading which is shown in FIG. 21.

In this view FIG. 21 shows a resulting graph 525 which includes a first reading of a contestant carrying a CCD 10 wherein loop 530 shows a reading for a contestant that is positioned at approximately 5 meters from an inside rail on the track. Loop 440 shows a reading for a second contestant that is positioned approximately 10 meters from an inside rail on a track. Using these readings, the system can determine a point at which a contestant crosses a particular point on a track such as the gap between the two dipoles 500 and 510 which is shown by the dip in the two loops at position or reading 0 on the graph. In addition, based upon the height or amplitude of these loop readings, the user can also determine the distance each competitor is located from the rail so that the exact position of each competitor is known either throughout the race or at particular points during the race such as at the finish line or at a halfway mark.

In the embodiment of the invention shown in FIG. 20, the current distribution of the dipole 500 and 510 is assumed to be uniform. While this assumption in general is not true, this is because the current drops down to 0 at the end of the dipole. However the current can be made near uniform if the dipole is end loaded with a large capacitance.

To determine the position of a competitor using this device the magnetic field of a single piece of wire of length L is calculated wherein this length stretches from (−L/2, 0) to (L/2,0) wherein the carrying current is I.

Thus, by using the Biot-Savart law

$$ⅆ B = \frac{{μ}_{0}}{4 π} \cdot I \cdot \frac{ⅆ \overline{x} * \overline{R}}{{R}^{3}}$$

This formula can be translated into

$$\overline{ⅆ} x * \overline{R} = {\overline{e}}_{x} \cdot ⅆ x \cdot R \cdot \frac{b}{R} = {\overline{e}}_{z} \cdot ⅆ x \cdot b$$

wherein \overline{e}ₓ in the Z direction.
Thus by substituting R wherein
R=√\overline{b²+(a−x)²}

This results in the formula:

$$ⅆ \vec{B} = \frac{{μ}_{0}}{4 π} \cdot I \cdot {e}_{x} \cdot \frac{b}{{[ \sqrt{{b}^{2} + {( a - x )}^{2}} ]}^{3}} \cdot ⅆ x$$

wherein
u₀ is a magnetic constant
b is a distance from a rail
a is a position along a rail with respect to the magnetic field
x is a integral number to determine the position of the competitor

The total magnetic field can be obtained by integrating:

$$\overline{B} = \frac{{μ}_{0}}{4 \cdot π} \cdot I \cdot {\overline{e}}_{x} \cdot {\int }_{\frac{- L}{2}}^{\frac{L}{2}} \frac{b}{{[ \sqrt{{( x - a )}^{2} + {b}^{2}} ]}^{3}} ⅆ x$$

by solving the integral the following formula is used

$$\int \frac{b}{{[ \sqrt{{( x - a )}^{2} + {b}^{2}} ]}^{3}} ⅆ x = \frac{x - a}{b \cdot \sqrt{{( x - a )}^{2} + {b}^{2}}}$$

$$Let f ( ) I ( a , b , x ) := \frac{x - a}{b \cdot \sqrt{{( x - a )}^{2} + {b}^{2}}}$$

Thus, to avoid a division by zero for b=0, the function can be modified slightly, this will only affect the values of the field or fields for the points that are very close to the loop, and for those values that are of no interest. For example:
g(b):=if(|b|<0.01, 0.01,b)
where
g(b) is
b is the position from the rail
   f( ) (a,b,x,):=f( )1(a,g(b),x)
f( ) is the function performed on the variables
a is the position along the rail from the magnetic field;
b is the position from the rail;
x is the position of the competitor;

For simplicity sake, the constant multiplier

$$\frac{{μ}_{0}}{4 π} \cdot I \cdot {e}_{x}$$

will be taken out wherein this will be added at the end.

The formula for the magnetic field of a straight piece of wire stretched between (−L,0) and (0,0) and measured at a point (a,b) is:
B1(a,b,L):=f( ) (a,b,0)−f( )(a,b,−L)

In addition, a second piece of wire between (0,0) and (0,L) then this can be measured using:
B2(a,b,L):=f( )(a,b,L)−B2(a,b,L).

When using this device with a logarithmic amplifier the field, which can change very sharply, is now readable even in very small fields as very large ones to compress a dynamic range. FIG. 21 shows the dynamic range for this type of readout of a signal using a logarithmic amplifier.

For example, the output of a carrier communication device can be calculated as:
CCDOUT(x):=max[55, min [255, (256/1.25)*log(|x|+0.000000000000001)+2.25]]
I:=1

This current invention provides a system that creates a timing system to report both time and rail position for each competitor. At each fraction of the track, a “Rail Position Loop” in the form of a rectangle frame with the dimensions of 20 m×10 m placed alongside a track. This loop generates a magnetic field with the same frequency as the loops suspended over the track. FIG. 21 shows the field strength generated by each loop. Loops 501, represents the strongest zone while outer loops 502, 503, 504, and 505 represent weaker reception loops.

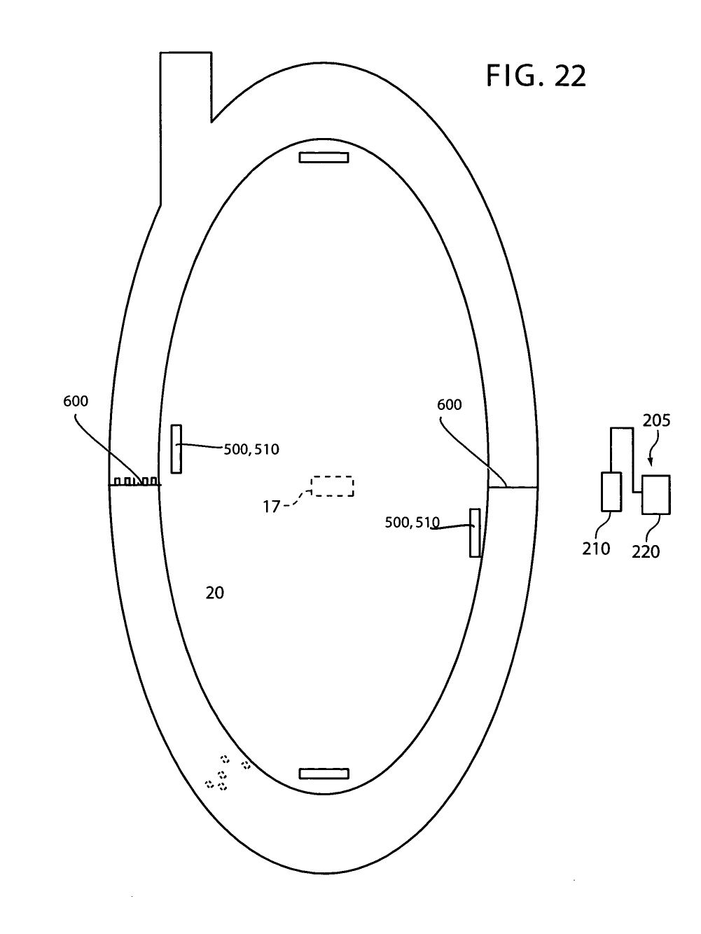

As a CCD or sensor passes by a loop, such as a loop shown on a track in FIG. 22 it tracks a maximum field value. When the field value starts to decline, the sensor stores the maximum value recorded so far. After each base station receives the rail position peak values from all competitors, it can determine their order and the distances between them with respect to the rail.

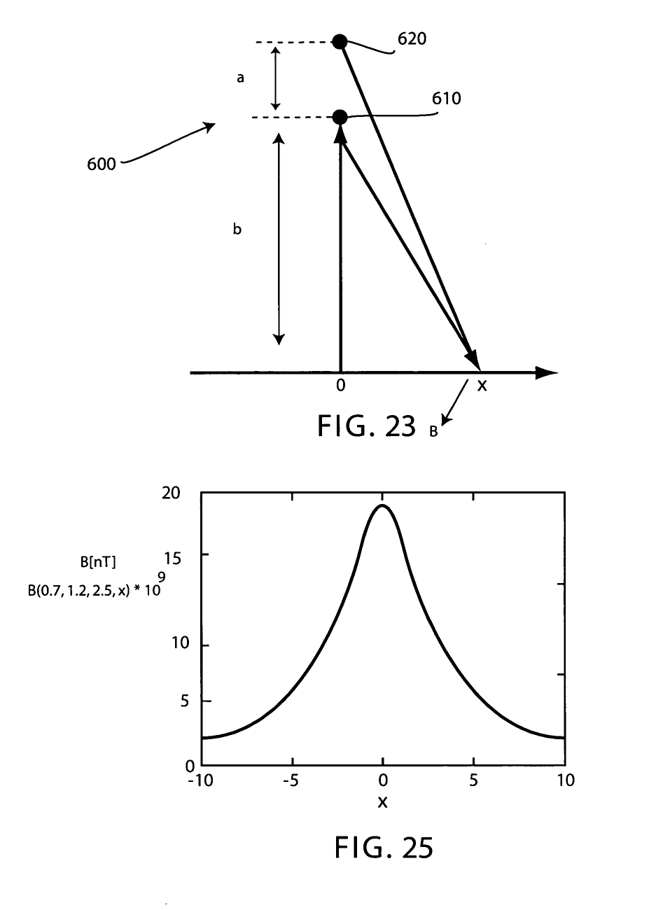

In another embodiment of the invention, as shown in FIGS. 22, 23 and 24 a vertical loop 600 which can include a bottom loop 610 and a top loop 620 can be used which can create a magnetic field which can be used to determine the position of a competitor around a track. This loop as shown by FIG. 24 and can stretch 30 meters across a racetrack. The height of the sensor path is 2.5 meters and the spacing between the two wires can be 1.2 meters.

The formula for the magnetic field can be derived for under the loop. For this formula a set of assumptions are made. First, there is an assumption of a loop that is long wherein the sensor crosses in the middle so that the formula for a infinite wire can be used. This is shown by:

$$B ( r ) = \frac{{μ}_{0}}{4 π} \cdot 2 \cdot I \cdot \frac{1}{r}$$

wherein
B is the magnetic field strength
r is the distance from the wire
I is the carrying current

The positions of these wires can be in the form of complex numbers which are based upon the variables a and b wherein in this case variable a is the distance of the second wire from the lower wire while variable b is the distance of the first wire from the sensor. In this case, x is the position of the competitor along the rail, wherein:
p₁=i·b
p₂=i·(b+a)

The position of the sensor is then x+i·0=x

Thus the field produced by the lower wire (p1) at the location of the sensor is:
f(x−p₁)
wherein x is the position along the track.

The field produced by the second wire (p2) will be
−f(x−p₂)

In this case the “−” sign is because the current of the second wire flows in the opposite direction.

The total field magnitude then will be

$$B m ( a , b , x ) = \vert - ⅈ \cdot \frac{x - ⅈ \cdot b}{{( \vert x - ⅈ \cdot b \vert )}^{2}} -- i \cdot \frac{x - ⅈ \cdot b - ⅈ \cdot a}{{( \vert x - ⅈ \cdot b - ⅈ \cdot a \vert )}^{2}} \vert$$

After simplifying this formula then this becomes:

$$B m ( a , b , x ) = \frac{a}{\sqrt{( {b}^{2} + {x}^{2} ) \cdot [ {x}^{2} + {( a + b )}^{2} ]}}$$

By considering a plane perpendicular to a loop, the easiest way to calculate the magnetic field vector which provides the position of each competitor is by using complex numbers in that plane.

By selecting an x axis to be the line on which the sensor travels, the sensor position will become a complex number (x, 0).

By selecting a Y axis to go though the loop, so that as shown in FIG. 24, the lower wire crosses at a point (0,b) and the upper wire crosses through a point (0, b+a).

Thus, if we have a point z on the complex plane and there is an endless wire carrying current I, which is perpendicular to that plane, and crossing at 0, then the magnetic field produced by that wire will become a complex number having a magnitude and direction of:

$$B ( z ) = \frac{{μ}_{0}}{4 \cdot π} \cdot 2 \cdot I [ - ⅈ \frac{z}{{( \vert z \vert )}^{2}} ]$$

In this case, with the calculations being linear, the constant multiplier can be omitted

$$\frac{{μ}_{0}}{4 \cdot π} \cdot 2 \cdot I$$

wherein this constant multiplier can then be multiplied at the end, wherein μ₀:=4π·10⁷I.

Thus the multiplier becomes 2·10⁻⁷·I.

Thus, in this case the final formula for determining the field strength can be calculated as:

$$B ( I , a , b , x ) := 2 \cdot {10}^{- 7} \cdot I \cdot \frac{a}{\sqrt{( {b}^{2} + {x}^{2} ) \cdot [ {x}^{2} + {( a + b )}^{2} ]}}$$

An actual track as shown in FIG. 26 can be constructed wherein this track can have the following parameters:
I=0.7 amperes of loop current
a=1.2 meters
b=2.5 meters which is the distance between the path and the lower wire

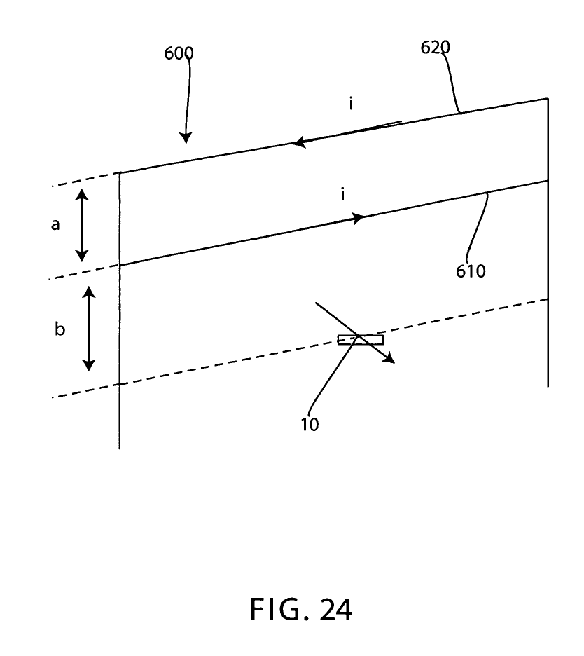

This field strength can then be shown in FIG. 25 which can be used to determine the position of the competitor along a position x in the track.

Thus, this system as well can be used to determine the position of a competitor as that competitor moves across a track.

Accordingly, while several embodiments of the present invention have been shown and described, it is to be understood that many changes and modifications may be made thereunto without departing from the spirit and scope of the invention as defined in the appended claims.

1. A competitor communication device which determines a particular time at a particular position of an individual contestant in a race and a position on a track of that contestant wherein the device is in communication with a remote processing station the device comprising:
a) at least one position sensor;
b) at least one microprocessor;
c) at least one transceiver coupled to said microprocessor;
d) at least one antenna coupled to said transceiver;
e) at least one audio input;
f) at least one video input; and
g) at least one power source coupled to said at least one microprocessor, said at least one transceiver, said at least one audio input, and said at least one video input;
wherein said at least one audio input and said at least one video input receive and transfer audio and video information relating to the events of the race to said microprocessor and said at least one position sensor receives and transfers information relating to the position of a contestant in the race to said microprocessor wherein said microprocessor sends said audio, video and position information through said transceiver and said antenna to the remote processing station.

2. The device as in claim 1, wherein said at least one position sensor comprises a coil coupled to a tuning capacitor, wherein said coil is positioned so that it receives a magnetic signal from an outside antenna set in the track at a particular position on the track wherein said coil receives a signal from said outside antenna and sends this signal on to said microprocessor, which then processes this signal and sends it on to the remote processing station to determine the position of the contestant in that race.

3. The device as in claim 2, wherein said position sensor further comprises at least one amplifier coupled to said coil, said power source, and said microprocessor wherein said amplifier amplifies said signal sent from said coil to said microprocessor.

4. The device as in claim 1, wherein said at least one power source comprises at least one battery coupled to at least one DC-DC boost converter.

5. The device as in claim 4, wherein said at least one power source further comprises at least one charger connection coupled to said at least one battery, said at least one charging connection for recharging said at least one battery.

6. The device as in claim 5, further comprising at least one LED display that indicates whether said at least one battery is running low on power.

7. The device as in claim 2, wherein said coil is positioned in an y-z plane so that it can recognize an x-component of the contestant.

8. The device as in claim 2, wherein said coil is positioned in an x-y plane so that it can recognize a z-component of the contestant.

9. The device as in claim 4, wherein said DC-DC converter produces 5 volts from said at least one battery.

10. The device as in claim 1 wherein said at least one microprocessor contains a set of instructions which creates a unique identity for said at least one microprocessor identifying the contestant using the device.

11. The device as in claim 10 wherein said microprocessor contains a synchronization protocol which sets periodic transmissions of signals from said at least one transceiver to said at least one remote processing station.

12. The device as in claim 10, wherein said microprocessor contains a time division multiple access (TDMA) protocol to set a periodic time for transmission to and from said transceiver to said remote processing station to avoid collision or interference of a signal.

13. The device as in claim 10, wherein said at least one microprocessor controls audio and video transmission from each contestant so that audio and video transmission is sent from only one contestant at a time.

14. A system for determining a particular position and a particular position of an individual contestant in a race and a position on a track of that contestant wherein the system comprises:
at least one loop disposed above the track and positioned at a particular position on the track;
at least one competitor communication device which can be coupled to each contestant; and
at least one remote base station, wherein said competitor communication device determines a contestant time as said contestant passes said at least one loop.

15. The system as in claim 14, wherein said loop comprises at least one loop formed as a trapezoidal loop.

16. The system as in claim 14, wherein said loop comprises at least two trapezoidal shaped loops.

17. The system as in claim 16, wherein said at least two trapezoidal shaped loops have a longitudinal axis that projects from an inside rail to an outside rail on the track.

18. The system as in claim 17, wherein said at least two trapezoidal shaped loops create at least one magnetic field having at least two nulls, wherein said at least one competitor communication device determines the distance between the nulls in said at least one magnetic field to determine the position of each individual contestant coupled to said at least one competitor communication device.

19. The system as in claim 18, wherein said at least one competitor communication device comprises at least one coil and at least one tuning capacitor wherein said at least one coil reads said at least one magnetic field transmitted from said at least two trapezoidal shaped loops to determine the position and timing of each individual contestant coupled to said at least one competitor communication device.

20. The system as in claim 18, wherein said at least one competitor communication device comprises at least one microprocessor which contains a set of instructions which creates a unique identity for said at least one microprocessor identifying the contestant using the device.

21. The system as in claim 20 wherein said microprocessor contains a synchronization protocol which sets periodic transmissions of signals from said at least one transceiver to said at least one remote processing station.

22. The system as in claim 20, wherein said microprocessor contains a time division multiple access (TDMA) protocol to set a periodic time for transmission to and from said transceiver to said remote processing station to avoid collision or interference of a signal.

23. The system as in claim 20, wherein said at least one microprocessor controls audio and video transmission from each contestant so that audio and video transmission is sent from only one contestant at a time.

24. The system as in claim 20, further comprising an infrared system positioned adjacent to each of said at least one loop wherein said infrared system determines when a competitor crosses a path on said infrared system.

25. The system as in claim 24, wherein said infrared system is placed at least a starting line and a finish line of a racetrack.

26. The system as in claim 14, further comprising at least one relay station for relaying and amplifying signals for transmitting information between said at least one competitor communication device and said at least one remote base station.

27. A process for determining the position and time at a particular position on a track for each contestant in a race, the process comprising the following steps:
attaching at least one individual contestant positioning device on at least one contestant;
starting a race;
recording the position and time of each of said at least one contestant during the race;
transmitting a signal including information relating to the position and time of each of said at least one contestant using a synchronized transfer protocol;
receiving a plurality of signal into at least one remote base station; and
synchronizing a plurality of receptions of said signals so that there is no interference.

28. The process as in claim 27, further comprising the step of projecting said information about said timing and position of said race contestants to a display system.

29. The process as in claim 27, wherein said step of projecting said information for display comprises the step of projecting said information to a display selected from the group consisting of: an an intranet website, an internet website, a television screen, an LED display, or a printer.

30. The process as in claim 27, wherein said step of recording the position and time of said at least one contestant during a race includes receiving a signal from at least one loop into said competitor communication device wherein said loop is positioned at a particular position on a track.

31. The process as in claim 27, wherein said step of recording the position and time of said at least one contestant during a race includes receiving a magnetic signal from at least two loops into said competitor communication device wherein a time and position of said contestant is determined via a set of nulls formed from said magnetic signal from said at least two loops.

32. The process as in claim 27, wherein the distance between said nulls in said signal is the distance between said loop wires and wherein said loop wires are trapezoidal in shape so that a distance from a rail or inside position on said track can be determined for each contestant based upon said nulls in said signals.
